(19) United States
(12) Patent Application Publication
(10) Pub. No.: US 2020/0111106 A1
(43) Pub. Date: Apr. 9, 2020

(54) METHODS AND SYSTEMS FOR AUTHENTICATING PRODUCTS

(71) Applicant: Charles Siebenberg, New York, NY (US)

(72) Inventor: Charles Siebenberg, New York, NY (US)

(21) Appl. No.: 16/495,770

(22) PCT Filed: Mar. 19, 2018
(86) PCT No.: PCT/US18/23198

§ 371 Date: Sep. 19, 2019

Related U.S. Application Data
(60) Provisional application No. 62/473,408, filed on Mar. 19, 2017.

(51) Int. Cl. G06Q 30/00; G06Q 10/08; G06Q 50/02; G06K 9/20; A47F 13/00; G09F 3/00

(52) U.S. Cl. CPC G06Q 30/018; G06Q 10/0838; G06Q 50/02; G06K 9/2054; G09F 2003/0208; G09F 3/0297; G09F 3/0288; G06K 2209/17; A47F 13/00

(57) ABSTRACT

Exemplary embodiments of a method of authentication of a food product, such as an animal (land or sea) or produce can be provided. The method can comprise tagging a food product with a unique code, obtaining an image of the food product contemporaneous with the tagging, recording vital information associated with the food product, the vital information including one or more of the image of the food product, a date and time the food product was tagged, a weight of the food product, a location the food product was obtained and a type of the food product, uploading the vital information to a computer server, and associating the vital information with the unique code so that the vital information is specific to each food product.

### CROSS-REFERENCE TO RELATED APPLICATIONS

This application relates to and claims priority from U.S. Provisional Patent Application Ser. No. 62/473,408 filed Mar. 19, 2017, the entire disclosure of which is hereby incorporated herein by reference.

### FIELD OF THE DISCLOSURE

The present disclosure relates to exemplary embodiments of methods and systems for tracking products, and more particularly, to methods and systems for tracking products in a supply chain.

### BACKGROUND

When consumers shop for produce, such as meat, fish, fruits or vegetables, they often do not have sufficient information about the produce, such as when it was harvested, where it came from, how it was transported, how long it has been in the supply chain and conditions to which it was susceptible in the supply chain. It is difficult for consumers to know how fresh or safe is the produce. Also, too often produce is mislabeled, and there is a lack of effective industry regulation to patrol these issues. The same is true for many other products for which this information is important or desired, e.g. pharmaceuticals, chemicals, electrical components, semiconductor materials and more.

Therefore, there is a need for a method and system for tracking products from the point of harvest, extraction or manufacture to the end user, and being able to immediately provide information about a product and its supply chain.

### SUMMARY OF DISCLOSURE

The embodiments of the present disclosure can provide for various products to be tagged and identified from the point of harvest or manufacture and throughout the supply chain process. A product can be any article or substance that travels through a supply chain from a point of creation to an end user. A product can be grown, harvested, manufactured or refined. The present application uses firm raised fish and other specific products only as examples of a product for which this disclosure could be used.

The embodiments of the present disclosure can improve traceability technology by adding multi-factor authentication, creating layers of security to the supply chain, guaranteeing the integrity of every product such as a fish from harvest to the point of sale. After a fish is harvested, it can be tagged with a unique code and photographed with a timestamp. This data can be transmitted to a server, where it can be joined with a host of other relevant data specific to the fish, such as feed formula and harvest time, as well as consumer friendly data about the species, including popular recipes and nutritional information.

As the product moves through its supply chain, its data can be verified and updated at each stop along the way creating a history of the product, from the processor, transporter, wholesaler, or consumer, each update can be sent and saved to the server, ensuring the integrity of the product, as well as its handlers. A quick reading or scan with an electronic device, or a mobile software application on the electronic device, allows customers to validate the source of the product being scanned. The exemplary embodiments provide seafood customers with the information necessary to make informed decisions about purchases, and create a transparent supply chain including authentication of a product.

For example, according to some exemplary embodiments of the present disclosure, a method of authentication of a food product, the method comprising tagging a food product with a unique code, recording vital information associated with the food product, the vital information including one or more of an image of the food product, a date and time the food product was tagged, a weight of the food product, a location the food product was obtained and a type of the food product, uploading the vital information to a computer server, and associating the vital information with the unique code so that the vital information is specific to each unique code.

In some exemplary embodiments, the unique code can be provided on a physical tag and applied to the food product. The unique code can be provided on at least three portions of the tag, wherein each of the three portions are separable from each other. In some exemplary embodiments, each unique code can have a first part and a second part, wherein each first part of each unique code is similar to the remaining first parts to identify the particular food product, and each second part of each unique code is different from the other second parts to identify a part of the particular food product. In some exemplary embodiments, the food product can comprise a fish. The vital information can include the date and location the fish was caught or harvested, the type of species of the fish, the temperature of the fish when harvested or caught and the weight of the fish.

In some exemplary embodiments, the method can comprise continually or periodically uploading travel information about the food product during a supply process that can include shipping and delivery of the food product, where any information uploaded is associated with the unique code and stored in the computer server. The travel information can include the temperature of the food product, the location, date and time the travel information is uploaded, and the retailer the food product is delivered to. In some exemplary embodiments, a scan of the unique code on a mobile electronic device causes the vital information of the food product to be provided to the mobile electronic device from the computer server. In some exemplary embodiments, an image taken by the mobile electronic device can be sent to the computer server and matched to the image stored on the computer server to identify the food product.

In some exemplary embodiments, a tag for authenticating a food product can be provided, comprising a display portion, an image portion on the display portion representing a sample image of a food product, and a unique code provided on at least three portions of the display portion, wherein each of the three portions are separable from each other, wherein each unique code has a first part and a second part, and wherein each first part of each unique code is similar to the remaining first parts, and each second part of each unique code is different from the other second parts. The first part of the unique code can identify the particular food product and the second part of the unique code can identify a part of the particular food product. In some exemplary embodiments, the first part of the unique code can identify a unique fish and the second part of the unique code can identify a body part of the fish.

### BRIEF DESCRIPTION OF THE DRAWINGS

The foregoing and other exemplary objects of the present disclosure will be apparent upon consideration of the following detailed description, taken in conjunction with the accompanying exemplary drawings and claim s, in which like reference characters refer to like parts throughout, and in which:

FIG. 1 is an illustration of a tag that can be provided on or with a produce item according to an exemplary embodiment of the present disclosure;

FIG. 2 is an illustration of a system by which produce can be authenticated according to an exemplary embodiment of the present disclosure;

FIG. 3 is an illustration of a produce photo booth for taking a photo of the produce according to an exemplary embodiment of the present disclosure;

FIGS. 4-12 are illustrations of a mobile application for authenticating produce according to an exemplary embodiment of the present disclosure;

FIGS. 13-19 are illustrations of a dashboard application for users to track and provide data of the produce ordered according to an exemplary embodiment of the present disclosure; and

FIG. 20 is an illustration of a system according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

The exemplary embodiments of the present disclosure can provide for methods and systems of tracking products during the supply chain, such as fish, meat, fruits, vegetables, pharmaceuticals and chemicals. Exemplary embodiments of the methods and systems will now be described with reference to the figures.

Although the methods and systems of tracking produce according to the exemplary embodiments of the present disclosure are not limited to any particular type of product, the exemplary embodiments will be described below using fish, where the fish is tagged once caught and information associated with the fish is stored throughout the supply chain process and provided throughout the supply chain through to a consumer.

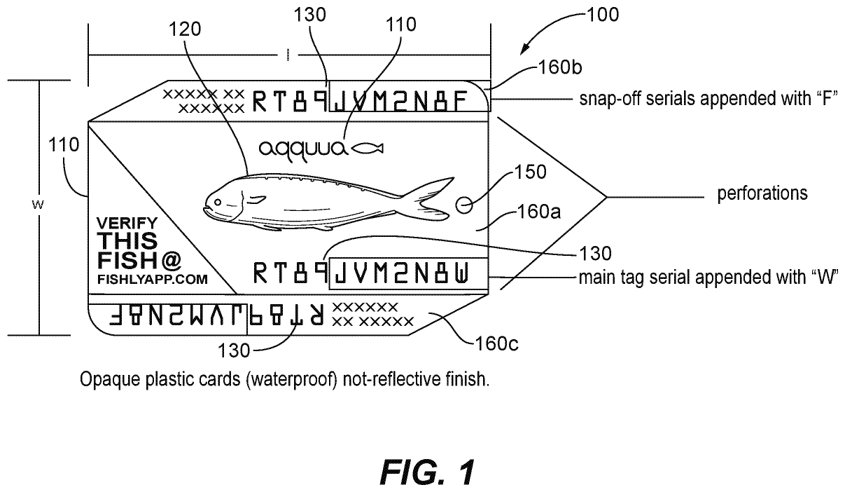

FIG. 1 is an illustration of a tag 100 that can be provided on or with a product, such as fish or other produce. In some exemplary embodiments, the tag 100 can be attached to the fish directly through a hole 150, such as on the fish's tail or a fin. For example, a string or other mechanism can be provided through the hole 150 and through the fish. The tag 100 can have one or more logo identification areas 110, which can include information such as the name and logo of the company selling the fish as well as a website or other information. An image identification area 120 can be provided having an image of the fish, which can be of the actual fish or an exemplary fish of the same species (e.g., a salmon photo for salmon fish). The entire first side of the tag 100 as shown in FIG. 1 can be a display portion in which the logo identification area 110, image identification area 120 and codes 130 can be provided. The tag 100 can be made of any type of material, such as but not limited to plastic (e.g., food grade plastic), paper, metal, glass or any composite thereof. The tag 100 can have any dimensions, and in some exemplary embodiments can have a length of two to four inches, and a width w of one to three inches, but is not limited to any particular width or length, and can be adjusted based on the size of the produce or as necessary.

A code 130 (e.g., “RT89JVM2N8”) can be provided that is specific to the actual produce item labeled, which once scanned by a consumer or other party, can provide information that will be more fully described below. The code 130 can be unique to the produce, and can be an alphanumeric code including a combination of letters (upper or lower case) and numbers, which can include symbols as well as other special characters. The code 130 according to the exemplary embodiments of the present disclosure is not limited to an alphanumeric code and can be any code for a type of tag, such as a barcode, Quick Response (QR) code, matrix code, readable code image, radio-frequency identification code for an RFID tag, near field communication code for NFC tags, or any type of code(s) and tag that can be read by, e.g., an electronic device. The code 130 can be provided with precision serial printing so easily readable by an electronic device,

In some exemplary embodiments, the code 130 can be provided in various sections of the tag 100, such as a middle portion 160a, and an upper portion 160 and a lower portion 160c, where each section contains the same or a related code 130. If the fish, for example, is cut into sections (e.g., fillets), the tag 100 can have one or more break-away sections (e.g., the upper portion 160b and lower portion 160c) that can snap off. Each part of the tag 100 contains the code 130 so that one section is kept with each fillet (e.g., strips in the tag 100 that can break off along tapered sections). For example, the middle portion 160a can have a similar code that ends in a “W” indicating the middle portion or main portion of the tag 100, and the fillets can include the upper portion 160b and lower portion 160c that snap off.

The exemplary embodiments are not limited to any particular number of break-away sections. For example, in some exemplary embodiments, a code 130 can be provided on seven sections of a tag 100 to provide seven break-away sections each containing the code 130 for a fish cut into seven portions. An identical code 130 can be provided for all seven pieces that can each also include the numbers 1-7, respectively, to differentiate between the seven pieces. In this manner, various produce (such as a watermelon cut into multiple pieces, or a fish cut into fillets, or a chicken cut into multiple parts) can be provided with a single tag 100 that can be broken off so that each part includes at least one portion of the tag 100 comprising the unique code 130. Each portion of the tag 100 that is broken away can include the code 130 so that the produce information can be tracked and stored.

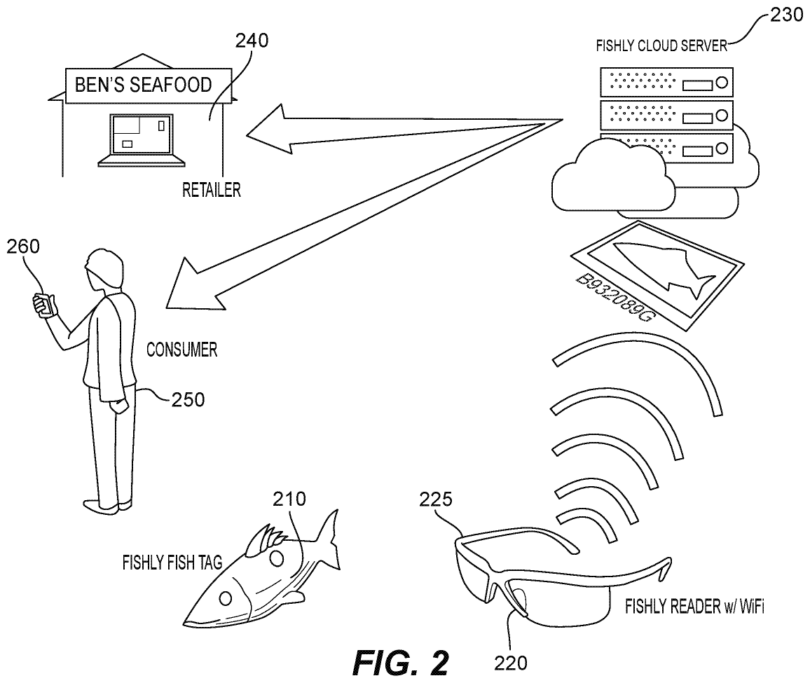

FIG. 2 illustrates a system by which produce can be authenticated according to the exemplary embodiments of the present disclosure. Once a fish 210 or other produce is harvested, a tag 100 containing a code 130 as described above can be applied to the produce 210 at the point of harvest (e.g., when a fish is caught or brought onto or off of a boat). In some exemplary embodiments, only a code 130 can be provided initially to the fish 210, and a tag 100 can be applied later containing the remaining information described above. A photo of the fish 210 can be taken using a camera 220 (e.g., a digital camera, or a digital camera provided on glasses 225 or a helmet), and other information can also be recorded and uploaded to a computer server 230, such as but not limited to the photo, time, date, code, birth location, location of harvest (e.g., fish farm or ocean), type of fish and weight. All this information can be stored on the computer server 230 in a record related to the code 130, which can be unique to the particular fish 210.

Once this information is uploaded to the computer server 230, additional information can be matched to the code 130, such as information about the species of fish, the farm where the fish is from (or other location information such as the river, ocean, etc. in which it was caught), temperature of the water in which it was caught, nutritional information, handling information, recipes, rich media (e.g., video of a recipe) and other related information about the fish 210. Information such as the date and location of where the fish 210 was packaged, shipped, how long it remained in the shipping process, the temperature it was kept during the shipping process, and other related information can be uploaded and stored during the process in the supply chain to the computer server 230. The date the fish 210 was delivered to the retailer 240 and location of the retailer 240 can also be uploaded and saved to the computer server 230 and related to the code 130.

When a consumer 250 scans the code 130 using, e,g., an electronic device 260, a request can be sent to the computer server 230 for information corresponding to the code 130. The electronic device 260 can be a mobile device, handheld device, handheld computer, mobile phone, cellular phone, smartphone, tablet computer, personal digital assistant, laptop computer, or any other electronic device that can connect to a server, and is not restricted to any of the above. The electronic device 260 can have a scanner or camera to view and recognize the code 130, and can have a capability to connect, wirelessly or with a wire, to a server. Once the code is recognized by the electronic device 260, a request is received by the computer server 230 from the electronic device 260.

Information stored on the server 230 and associated with the code 130 such as the photo of the fish (to visually match the fish) can be provided back to the electronic device 260 from the computer server 230, as well as other information, including but not limited to any information related to the code 130 described above, such as the date and location of the point of harvest, handling information, storage and shipping information, information about the species of fish, price information, nutritional information, recipe information and other related information. The consumer 250 is able to authenticate the fish 210, as well as find other related information about the fish 210 to help the consumer decide whether to purchase the fish 210. The consumer 250 can receive a two-step authentication, one from the photo received from the computer server 230 to match with the fish 210 at the retailer 240, and authentication based on the code 130. In some exemplary embodiments, each time a consumer 250 reads or scans the code 130, a history can be recorded of each time a consumer 250 is authenticating the fish 210, along with other data, such as date, time, retailer, location and other related information.

In some exemplary embodiments, the computer server 230 can provide a freshness score on a scale (e.g., 1-100), based on an algorithm that weighs and takes into account information such as the amount of days from the point of harvest to the date the consumer requests the information, the temperature the fish was kept and other handling information, the quality of the farm or location where the fish was harvested, and other related information. The score can provide a level of confidence in the quality of the produce.

In some exemplary embodiments, a produce photo booth 300 can be provided for taking a photo of the produce 210. For example, once the fish 210 is tagged with a tag 100, the fish 210 can be placed on, e.g., a conveyor belt 320. The conveyor belt can transport the fish through a photo booth 300 having a waterproof camera housing 310 with a camera or scanner inside the housing 310. LED lights 330 can be provided inside the housing 310 for the photo or scan. Once the camera takes the photo of the fish 210, it can also record the code and other information on the tag 100, and store this data on the computer server 230. The camera or scanner inside the photo booth 300 can include software that has the ability to read the code on the tag 100, identify the species of the fish (or fillet), based on a visual or biometrics of the fish 210. The photo booth 300 can also provide a timestamp on the photo, including the date, time and location of the photo, and upload this information to the computer server 230.

In some exemplary embodiments, the camera inside the housing 310 can also pick up fish biometrics, such as one or more of facial recognition, pattern of the fish, eye recognition, the fish size, the fish scale, the dorsal fin and other biometric information. This information can also be uploaded to the computer server 230. When a user 260 scans the code 130 on their electronic device, this information can also be matched to the fish, in lieu of the code 130, or in combination with the code 130 for an extra step of authentication of the fish 210.

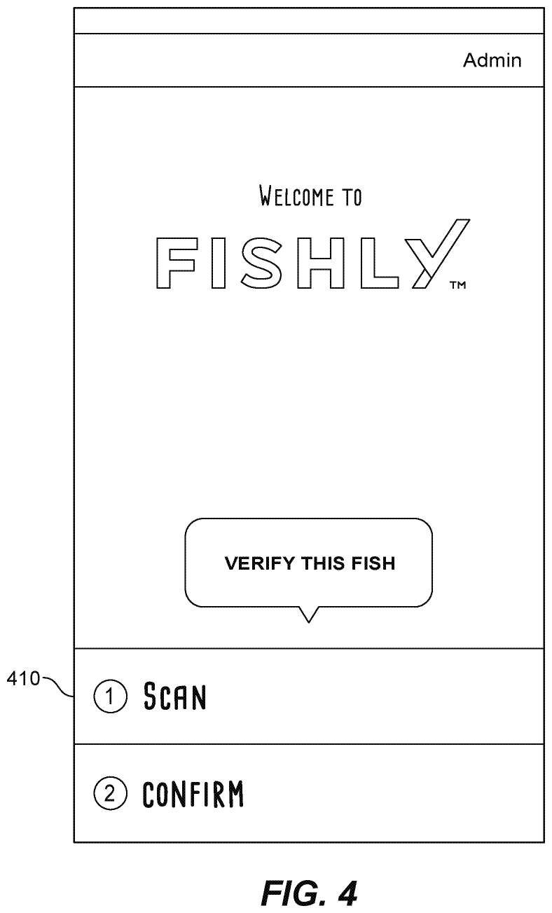

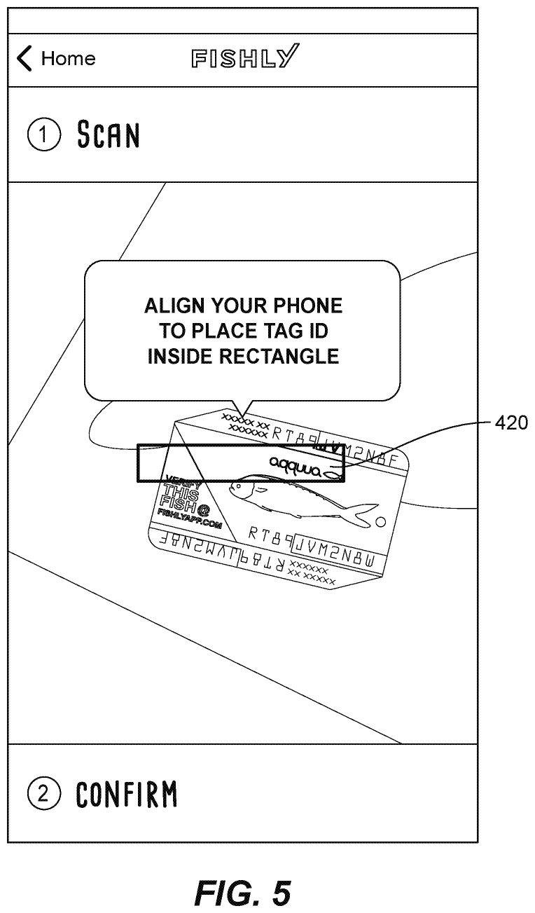

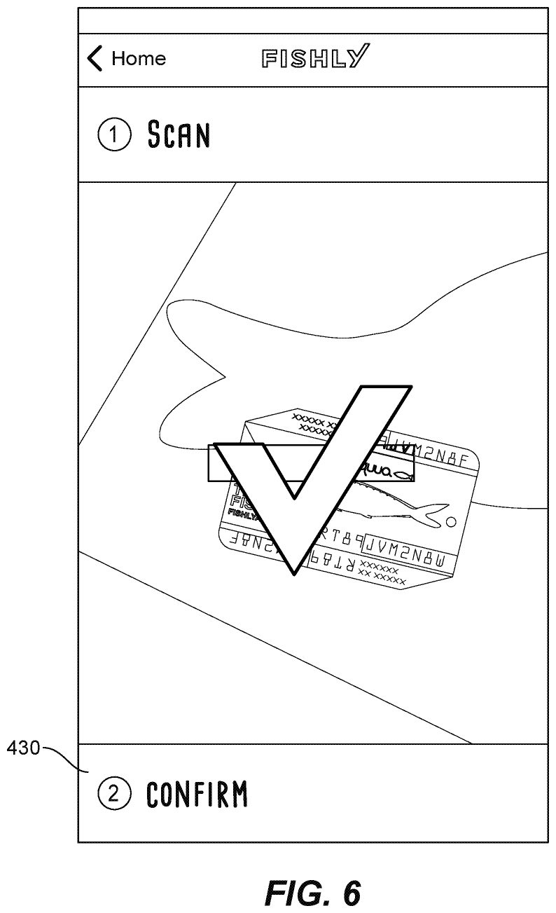

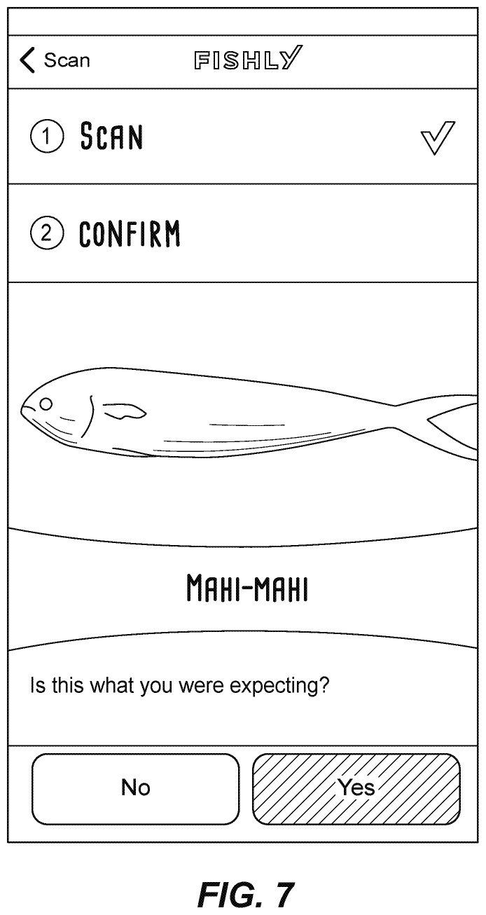

In some exemplary embodiments, a mobile application (e.g., a software application design to run on electronic devices such as smartphones, tablet computers and other mobile devices) can be provided on the electronic device 260 to read the code 130 and send the request to the computer server 230, and receive information about the fish 210 in the mobile application on the electronic device 260. For example, as shown in FIGS. 4-12, a mobile application for authenticating produce is provided according to the exemplary embodiments of the present disclosure. As shown in FIG. 4, a first step 410 of the mobile application can involve a “SCAN” step to verify and authenticate the fish. As shown in FIG. 5, a field 420 can be provided within the mobile application to read the code 130. The user can place the code 130 within the field 420 for the electronic device to scan the code 130, which is sent to the computer server. If the code 130 is recognized by the computer server, a confirmation step 430 is provided by the computer server to the mobile application, as shown in FIG. 6. A photo of the fish that was scanned can also be sent from the computer server to the mobile application for display in the mobile application, including the identification of the type of fish, as shown in FIG, 7, where the user can be asked if this was the fish they were expecting.

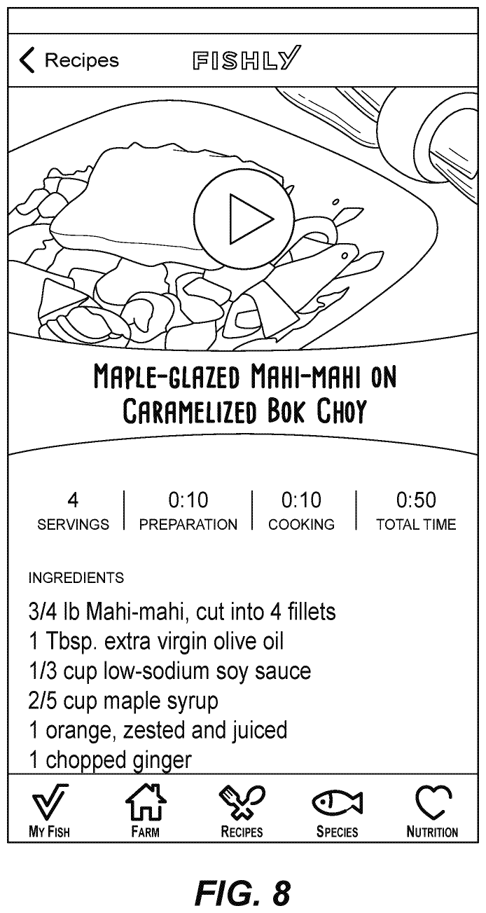

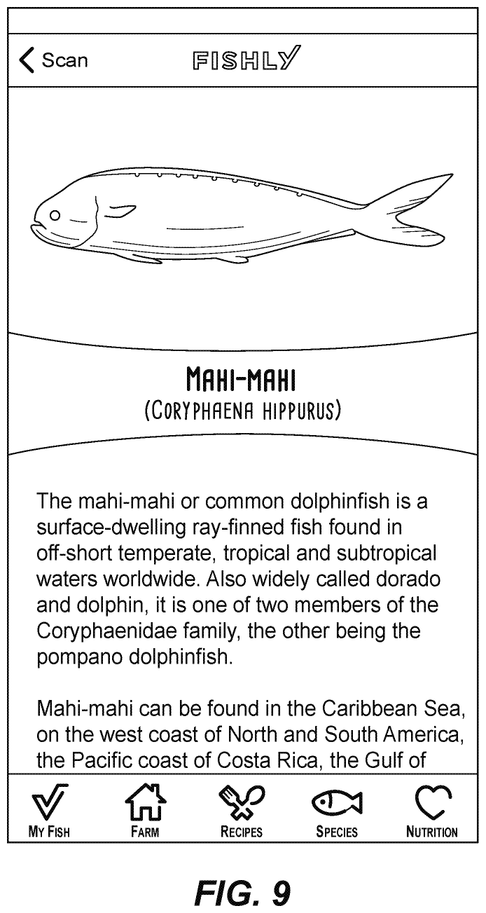

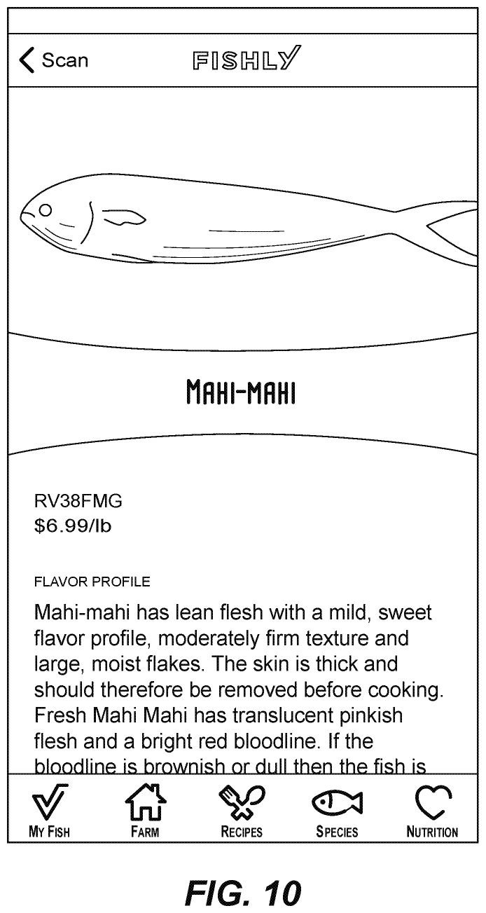

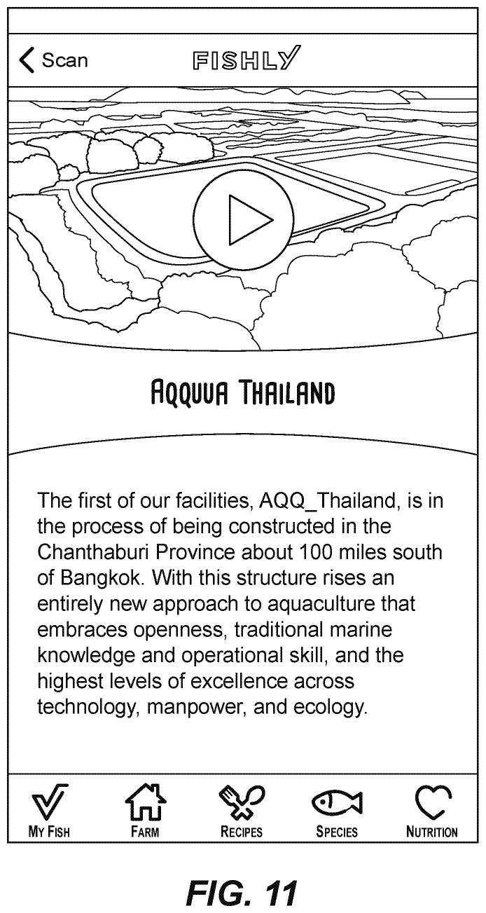

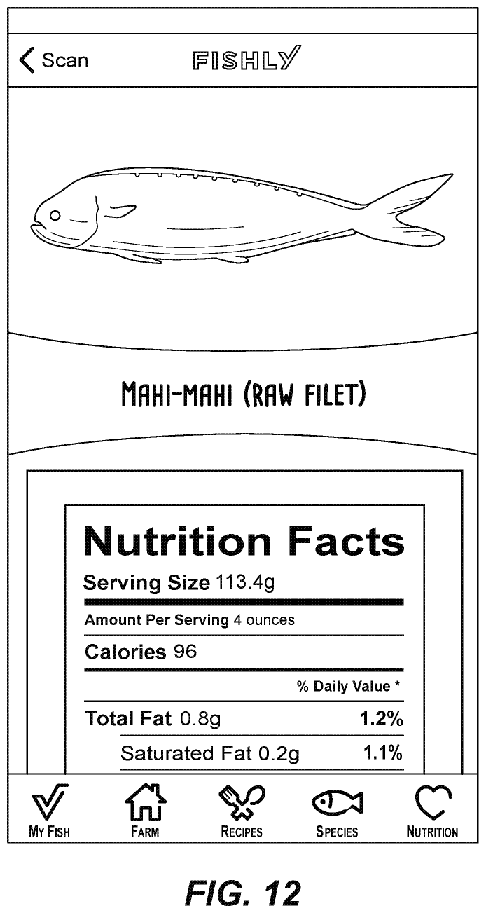

If the user confirms the type of fish at this step, then other information can be provided back to the user through the mobile application. For example, as shown in FIG. 8, one or more recipes for the type of fish can be provided through the mobile application. As shown in FIGS. 9-10, information about the type of fish including price information and flavor information can be provided to the user through the mobile application. As shown in FIG. 11, information about the location of where the fish was harvested, such as farm information, can be provided to the user through the mobile application. Nutritional information about the type of fish can also be provided to the user through the mobile application, as shown in FIG. 12. Rich media can also be provided to the user through the mobile application, relating to the recipes, farm information, and nutritional information. In some exemplary embodiments, geo-targeted offers from retailers can be provided through the mobile application to the user.

In some exemplary embodiments, the computer server 230 can send data to consumers through the mobile software application in, e.g., real time, based on one or more factors. The data can be based on geography, the species or type of fish, or other criteria. The data can also be sent to a specific code or set of codes that were scanned using the software application. For example, data can be sent to all mobile software applications that scanned a salmon (which can be recognized by the computer through the code scanned). The data can include but is not limited to specials, new deliveries, recipes and health/nutritional information. Notifications can be provided in the mobile software application of any new information sent to the mobile software application through the computer server.

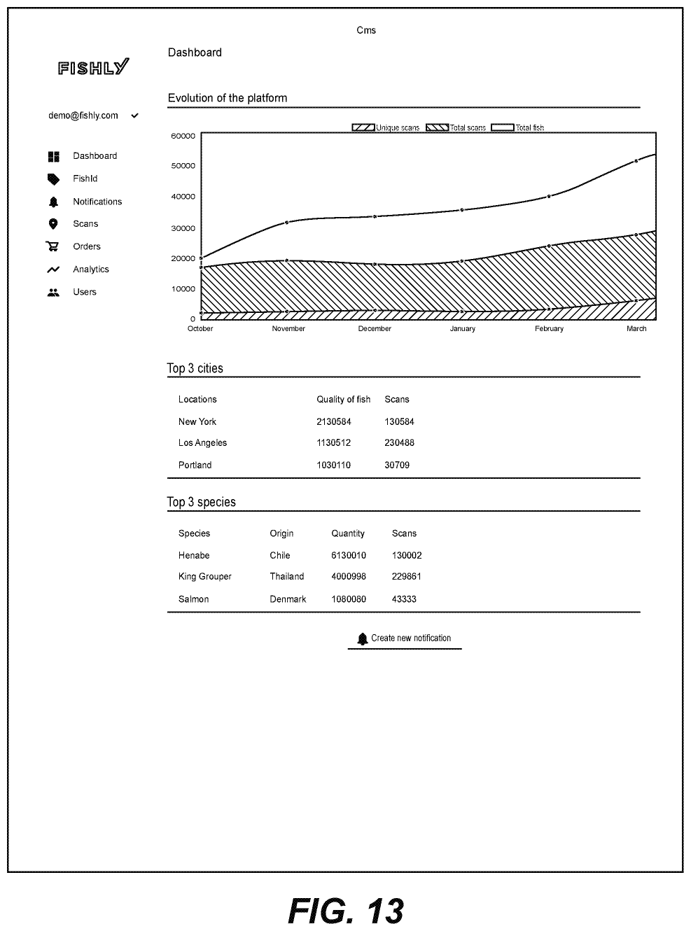

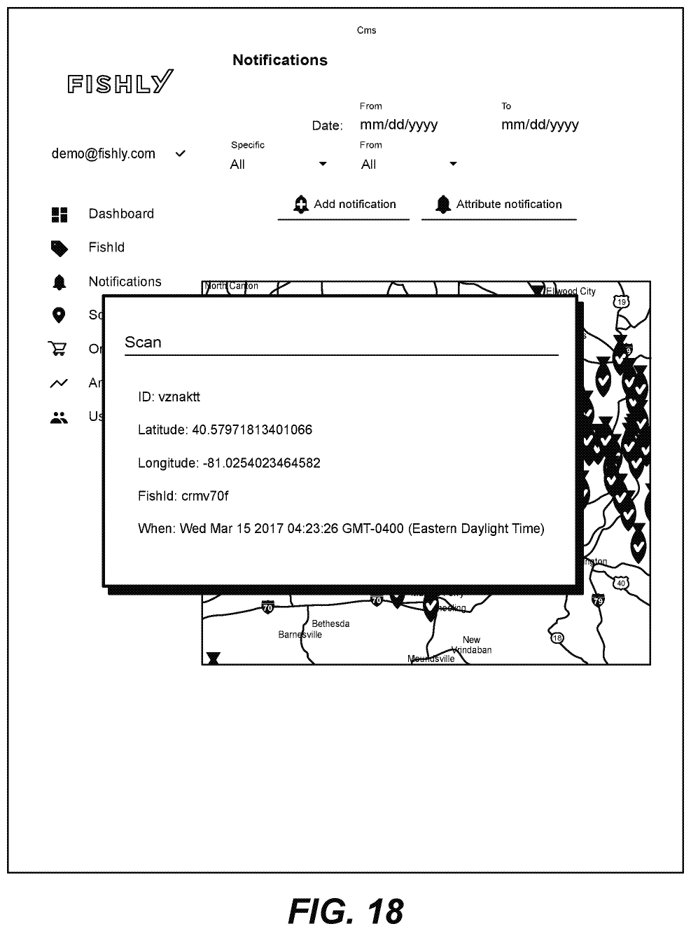

In some exemplary embodiments of the present disclosure, a dashboard application for users can be provided to track and provide data related to the product (e.g., fish) ordered by a user from a supplier, as shown in FIGS. 13-19.

For example, as shown in FIG. 13, a dashboard can be provided either via the Internet (e.g., web site) or through a mobile software application, in which each party along a supply chain can have a unique ID and password for access. The dashboard application can provide a graph displaying the total number of scans of the fish ordered by the particular user or wholesaler or retailer by month or year, and the total number of scans of all the fish ordered. The dashboard can further provide the quantity of fish ordered by location or by species, and can include the total amount of scans as well as the origin of the species (e.g., by country, ocean, river or farm). Other related information can be provided on the dashboard, which can be customized by the user as to the particular information they choose to display on the dashboard.

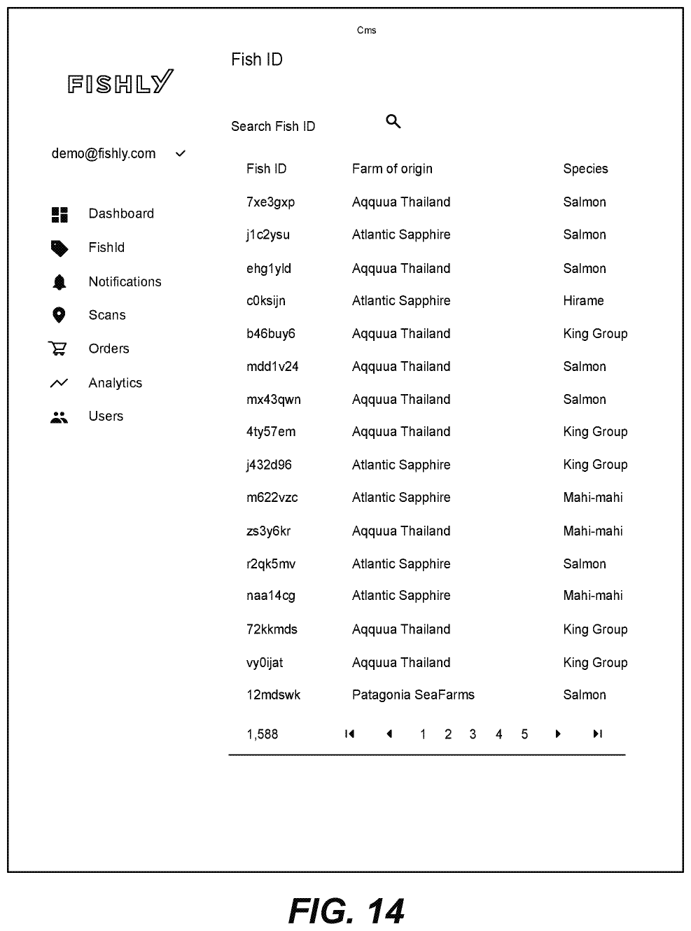

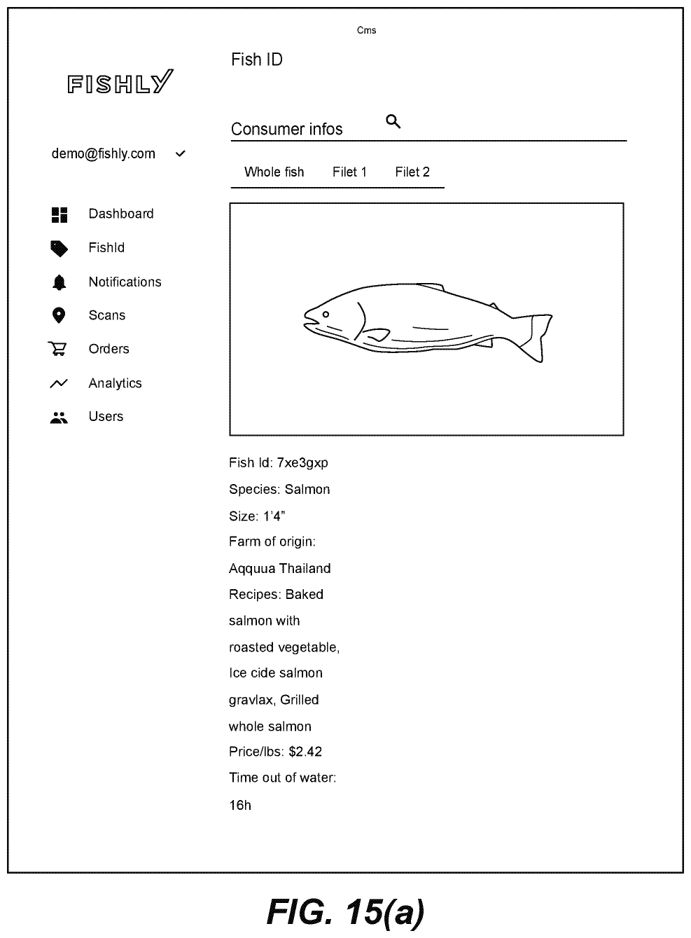

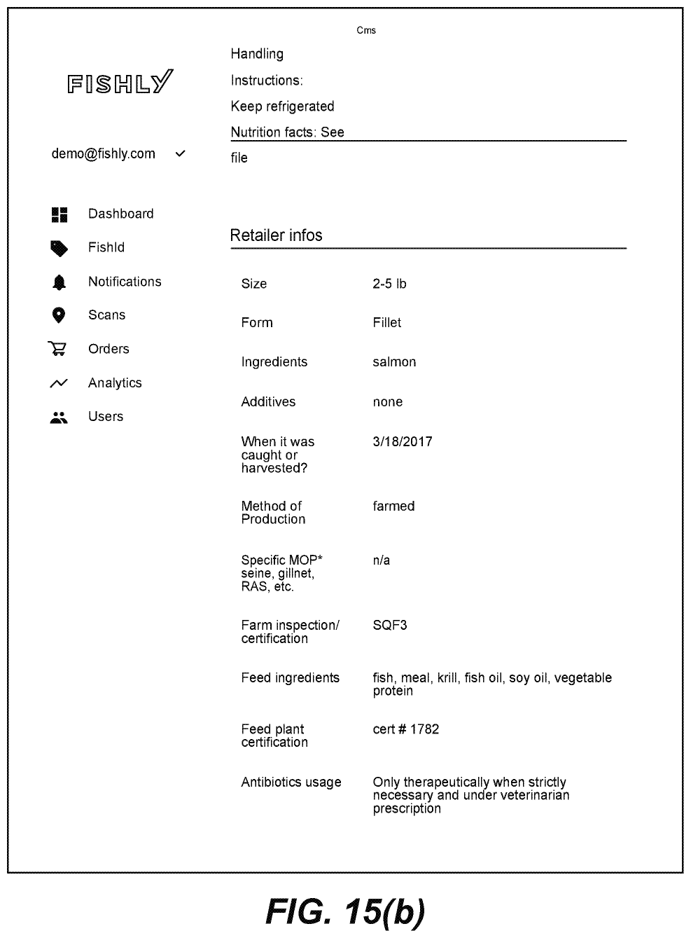

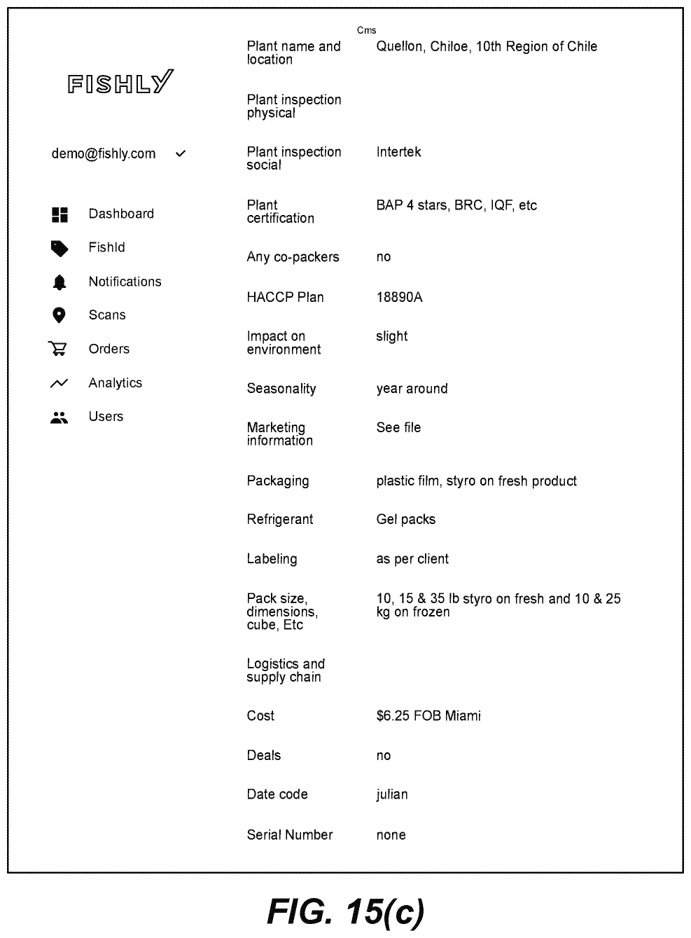

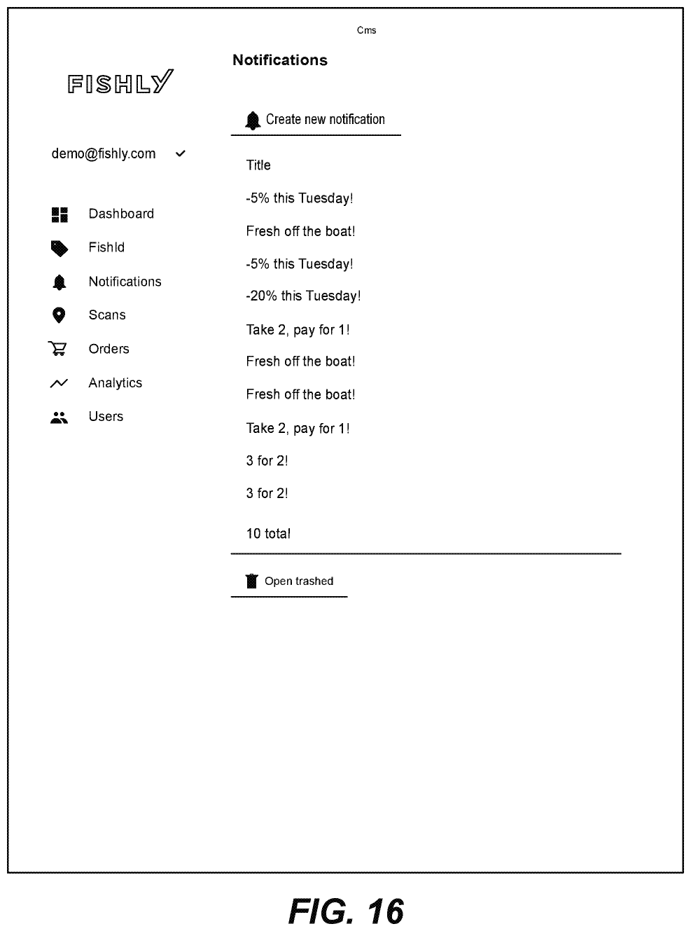

As shown in FIG. 14, a “FishId” tab can provide a chart of all the unique codes of the total fish ordered by the user, and can include other relevant information, such as the origin of the fish (e.g., name of the farm) as well as the species of the fish. The chart can be personalized and grouped by any column, such as the code, the farm, the species, or by date ordered. When a user clicks on the actual code under “Fish ID” (e.g., “7xe3gxp”), information as shown in FIGS. 15(a)-15(c) can be provided, displaying a photo of the actual fish based on the unique code, and other data based on the code, such as species, size, origin, price, time out of water and other related data. A “Notifications” tab can be provided that can provide messages or specials directly from the fish supplier to the wholesaler or retailer, which can include daily or weekly specials, as shown in FIG. 16.

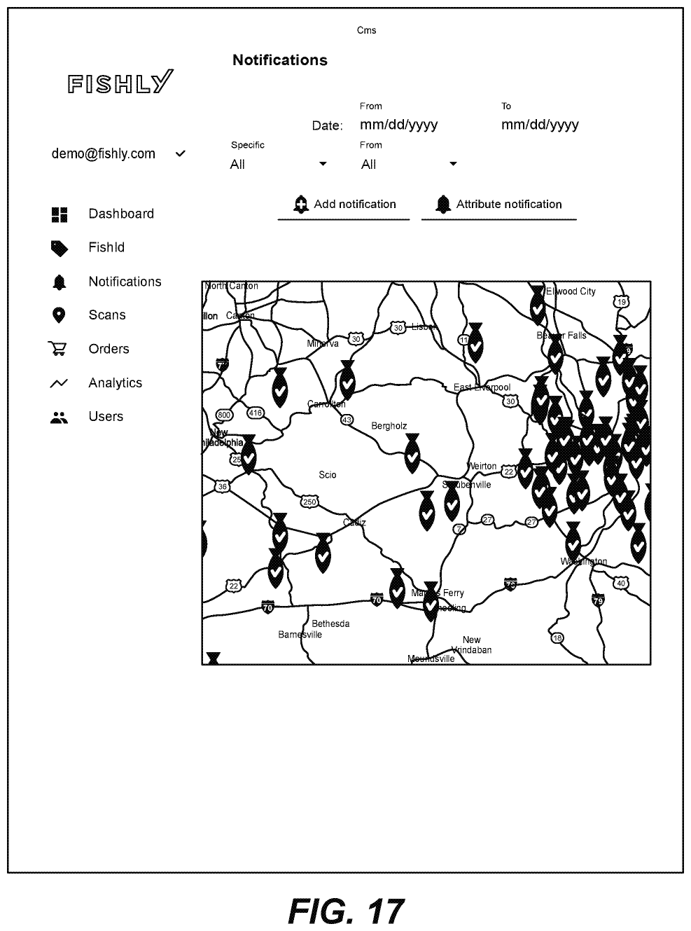

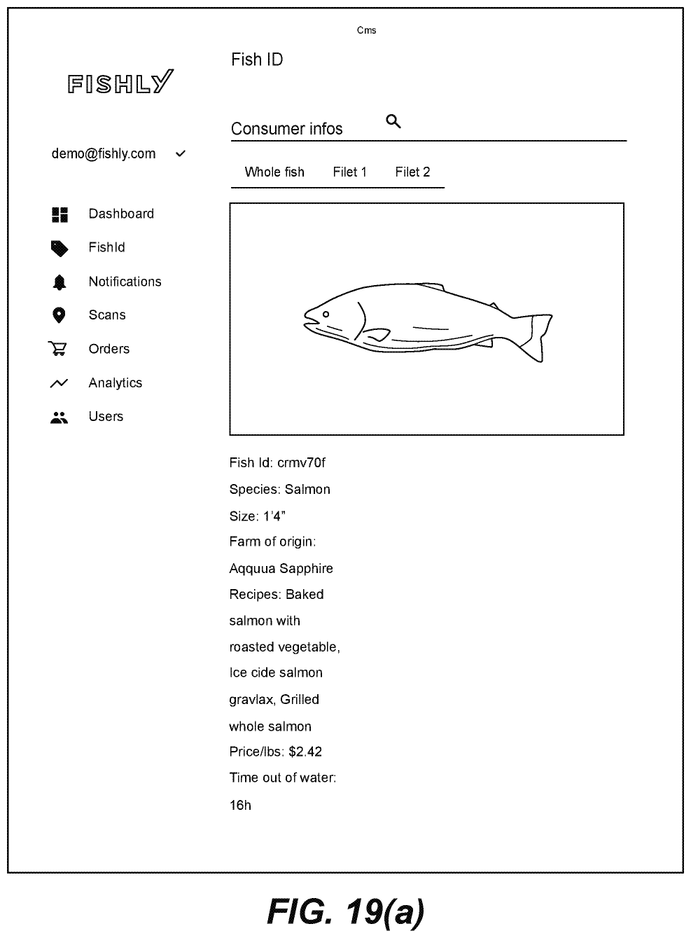

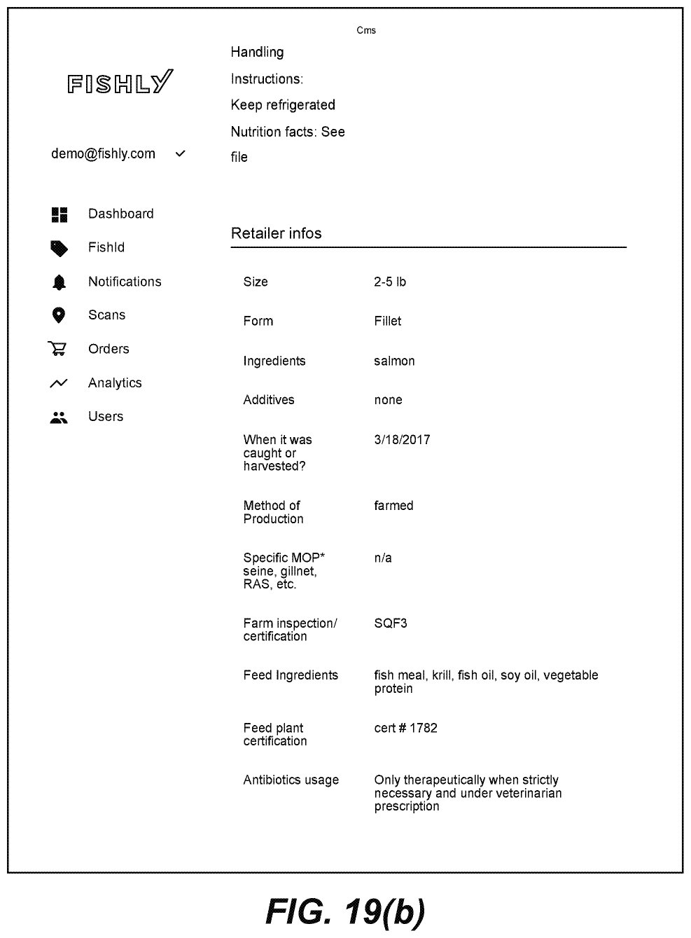

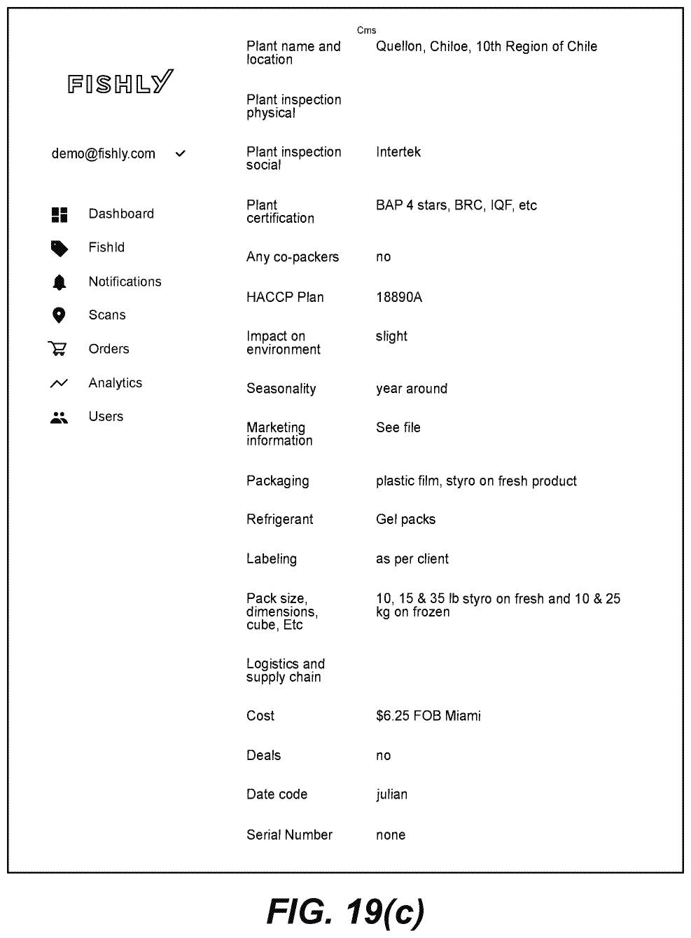

A “Scans” tab can be provided that displays each fish ordered by the wholesaler or retailer on a map of locations where the fish is presently located, which can be indicated by a fish icon, as shown in FIG. 17. The user can zoom in or out to focus on a particular geographic location. When the user clicks on one of the fish icons, a pop up window can be provided, as shown in FIG, 18, which can provide the unique code, and the location (e.g., by latitude and longitude). If the user clicks on the FishID (the unique code of the fish), information regarding the particular fish can be provided, such as the unique code, photo, species, size, origin, price, time out of water and other related data, as shown in FIGS. 19(a)-19(c).

In some exemplary embodiments, data can be sent to dashboards of various users based on the code or other factors in real time. The data can also be sent to a specific code or set of codes that were scanned using the software application to different users based on the codes. For example, data can be sent to all dashboards that include a code for a salmon, such as a special on salmons. The data can include but is not limited to specials, deliveries, recalls or other data. Live notifications can be provided through the dashboards.

In some exemplary embodiments, an “Orders” tab can be provided, providing all past and pending orders from the wholesaler or retailer to the fish supplier. The status, prices and details of the orders can be provided under order numbers. An “Analytics” tab can also be provided, which can provide various information particular to the user, such as the most inquired about species (based on e.g., number of scans), location of most inquiries or scans, and analyze all the data uploaded to the computer server about the various fish. This can also include information about the transporters and delivery companies, such as how long and what conditions the fishes were transported in. A “Users” tab can be provided, which can provide various users assigned by the wholesaler or retailer that can have certain rights, such as placing or viewing orders.

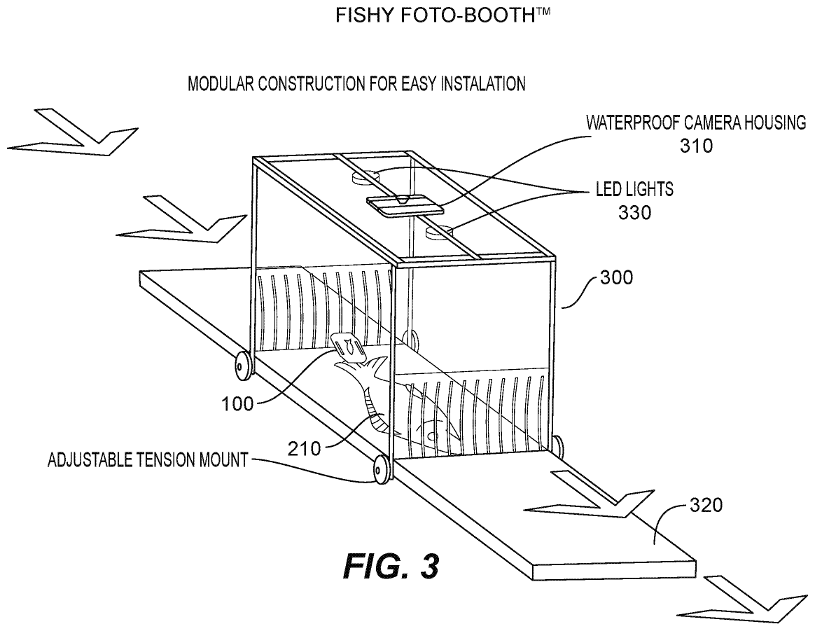

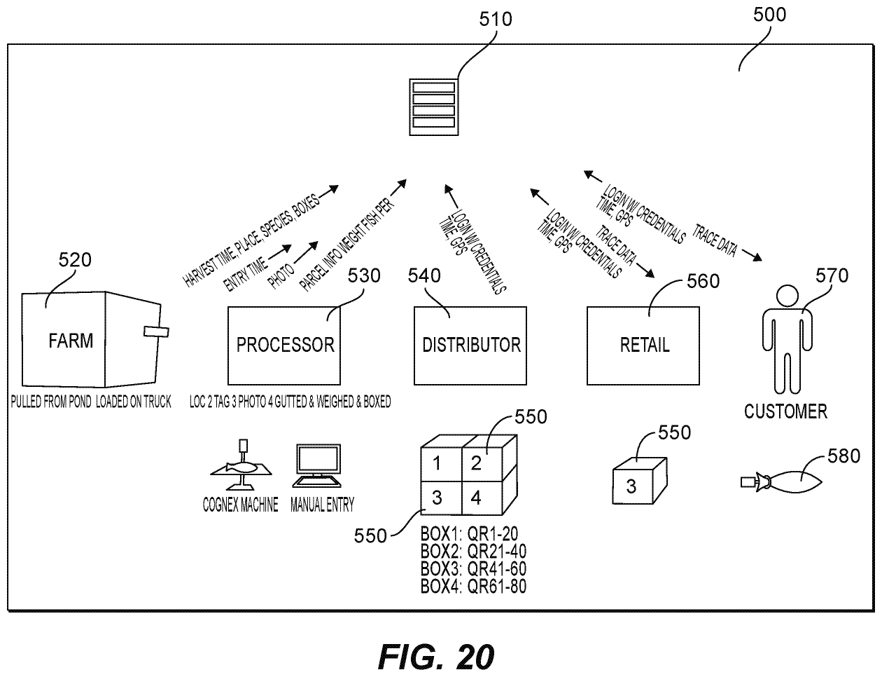

FIG. 20 is an illustration of a system 500 according to an exemplary embodiment of the present disclosure. As shown, the system can comprise a computer server 510. A farm or place where the food product or fish is obtained is shown as 520. A processor 530 can be provided where the fish is provided with a unique code and tagged with the unique code. For example, at this step, the photo booth of FIG. 3 can be provided at this stage. The fish can be gutted into several portions at this stage, each provided with the unique code, weighed and boxed into various boxes 550. All this information can be uploaded to the computer server 510. A distributor 540 can pick up the boxes and enter their credentials which are uploaded to the computer server 510, and can access the uploaded information associated with the boxes they are distributing. The distributor can also upload further information associated with the boxes 550 for each unique code as the distributor delivers each box to various retailers 560 along the supply chain. Each retailer 560 can enter their credentials to the computer server 510 and access the uploaded information associated with the food products they received in each box 550 based on the unique codes provided for each food product in that box 550. A consumer 570 at the retail location 560 can use their mobile electronic device to scan the unique code, and access the information associated with that unique code for the particular food product 580.

Various other considerations can also be addressed in the exemplary applications described according to the exemplary embodiments of the present disclosure. For example, the exemplary embodiments of the present disclosure can be applicable to various types of produce, such as farm animals (cows, chicken, pigs, turkey and other meats), fish, fruits and vegetables. In some exemplary embodiments, the above technology can also be applied to items that are manufactured, such as pharmaceutical drugs or other medications. Information about any of these can be provided based on a code associated with the item when harvested or manufactured at the point of origin or some other point along its supply stream. Transition points and information about the handling can be uploaded as the item is shipped from the point of origin to the retailer to give a consumer confidence about the item they are selecting at a retailer location. Various information about the product, such as dates, locations, nutritional, price, and other related information described above can be provided to a user on an electronic device (e.g., using a mobile software application). An algorithm performed on the system (which can differ based on the produce) can be used to provide a user a freshness score giving a level of satisfaction to a consumer before they make a purchase.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure.

What is claimed is:

1. A method of authentication of a food product, the method comprising:
tagging a food product with a unique code;
recording vital information associated with the food product, the vital information including one or more of an image of the food product, a date and time the food product was tagged, a weight of the food product, a location the food product was obtained and a type of the food product;
uploading the vital information to a computer server; and
associating the vital information with the unique code so that the vital information is specific to each unique code.

2. The method according to claim 1, wherein the unique code is provided on a physical tag and applied to the food product.

3. The method according to claim 2, wherein the unique code is provided on at least three portions of the tag, wherein each of the three portions are separable from each other.

4. The method according to claim 3, wherein each unique code has a first part and a second part, and wherein each first park of each unique code is substantially the same as the remaining first parts, to identify the particular food product, and each second part of each unique code is different from the other second parts, to identify a part of the particular food product.

5. The method according to claim 1, wherein the food product comprises a fish.

6. The method according to claim 5, wherein the vital information includes the date and location the fish was caught or harvested, the type of species of the fish, the temperature of the fish when harvested, caught or transported and the weight of the fish.

7. The method according to claim 1, further comprising:
uploading information about the food product during a supply process that can include shipping and delivery of the food product, where any information uploaded is associated with the unique code and stored in the computer server.

8. The method according to claim 7, wherein the travel information can include the temperature of the food product, the location, date and time the travel information is uploaded, and the retailer the food product is delivered to.

9. The method according to claim 7, wherein a scan of the unique code on a mobile electronic device causes the vital information of the food product to be provided to the mobile electronic device from the computer server.

10. The method according to claim 1, wherein an image taken by the mobile electronic device can be sent to the computer server and matched to the image stored on the computer server to identify the food product.

11. A tag for authenticating a food product, comprising:
a display portion;
an image portion on the display portion representing a sample image of a food product; and
a unique code provided on at least three portions of the display portion, wherein each of the three portions are separable from each other;
wherein each unique code has a first part and a second part; and
wherein each first part of each unique code is similar to the remaining first parts, and each second part of each unique code is different from the other second parts.

12. The tag of claim 11, wherein the first part of the unique code identifies the particular food product and the second part of the unique code identifies a part of the particular food product.

13. The tag of claim 12, wherein the first part of the unique code identifies a unique fish and the second part of the unique code identifies a body part of the fish.
